(19) United States
(12) Patent Application Publication
(10) Pub. No.: US 2012/0207974 A1
(43) Pub. Date: Aug. 16, 2012

(54) COMPONENT COMPOSITE AND METHOD FOR MANUFACTURING A COMPONENT COMPOSITE

(76) Inventors: Martin Maier, Moeglingen (DE); Kai von Garnier, Deizisau (DE); Wilfried Aichele, Winnenden (DE); Juergen Lander, Stuttgart (DE); Nikolaus Hautmann, Ditzingen (DE); Michael Honer, Gerlingen (DE); Jens Koenig, Markgroeningen (DE)

(21) Appl. No.: 13/391,218

(22) PCT Filed: Jul. 2, 2010
(86) PCT No.: PCT/EP2010/059432

§ 371 Date: May 2, 2012

(30) Foreign Application Priority Data
Aug. 17, 2009 (DE) 102009028583.0

(51) Int. Cl. B32B 7/12; B32B 38/00; B05D 1/36; B32B 37/12

(52) U.S. Cl. 428/141; 156/60; 156/275.7; 156/272.8; 427/261

(57) ABSTRACT

A component composite, in particular for motor vehicle applications, including a first component having a first contact surface, the first contact surface having a surface structure which has a microstructure overlaid by a nanostructure, and including at least one second component having a second contact surface. A medium, in particular an adhesive layer, is situated for integral connection between the two contact surfaces of the two components.

### FIELD OF THE INVENTION

The present invention relates to a component composite, and a method for manufacturing a component composite.

### BACKGROUND INFORMATION

A component composite is described in German Patent Application No. DE 10 2008 040782 A1. For component composite, a microstructure overlaid by a nanostructure is produced on a first contact surface of a first component with the aid of a laser. Subsequently, the first component is extrusion-coated with a second contact surface by a second component, a tight connection between the two contact surfaces of the components being produced due to the surface structure on the first component.

Extrusion-coating of metal parts using plastic is conventional, macroscopic structures having undercuts, such as ribs or a waffle structure, for example, being provided on the metal parts in order to allow a form fit with the plastic material. Although the thermoplastics which are used do not adhere to the metal, with skilled exploitation of shrinkage tensions, gas tightness of the component composite may initially be achieved. This gas tightness is temporary in particular in the event of temperature and/or load changes or in the event of media influence, however.

Furthermore, chemically structuring the surface of metal parts and, using the injection-molding method, subsequently extruding a plastic part onto the surface structured in this way is described in patent applications of the TaiseiPlas Company.

A metallic flat seal having at least one metallic seal layer is described in German Patent Application DE 10 2004 034 824 B4. The metallic seal layer is provided with a surface structure, which is produced with the aid of laser radiation, and on which elastomeric material is applied.

Furthermore, conventionally, components are connected to one another using an adhesive, an interlayer of an adhesion-promoting agent, if necessary, in order to improve the connection between the adhesive and the surface.

### SUMMARY

An object of the present invention is to manufacture a component composite which distinguishes itself by a particularly high degree of tightness, in particular also after temperature and load changes or after media storage, such as those occurring in particular in component composites in the engine compartments of motor vehicles. The component composite is preferably to be reliably and permanently gas tight. Furthermore, an object is to provide a method for manufacturing a component composite so optimized.

All combinations of at least two of the features which are described below, and/or in the figures, are within the scope of the present invention. To avoid repetitions, features described with respect to the method are to be considered as described with respect to the device. Similarly, features described with respect to the device are to be considered as described and claimable with respect to the method.

In accordance with the present invention, is based on the idea of structuring the surface of the first component of the component composite is structured, by using an interlayer of the medium, in particular the adhesive layer, which integrally connects the components, before joining the two components, in such a way that a surface structure results which has a nanostructure in addition to a microstructure. The nanostructure is to be situated in such a way that it is located on the microstructure, i.e., in such a way that the microstructure is overlaid by the nanostructure. A first component surface-structured in this way ensures in a component composite an improved adhesion between the medium, in particular the adhesive layer, and the contact surface of the first component.

In one exceptionally preferred refinement of the present invention, it is provided that the second contact surface on the second component also has a surface structure having a microstructure overlaid by a nanostructure. It is thus possible to form particularly solid and tight connections between the two components.

The formation of the surface structures may alternatively be carried out with the aid of electromagnetic radiation, with the aid of electric structuring or with the aid of mechanical structuring so that the formation of the surface structure may be optimized depending on the application.

In one refinement of the present invention, it is advantageously provided that microstructure elements of the microstructure have a diameter in a size range between approximately 1 μm and approximately 999 μm. The nanostructure elements of the nanostructure particularly preferably additionally or alternatively have a diameter in a size range between approximately 1 nm and approximately 999 nm.

Laser radiation is particularly preferably used as the electromagnetic radiation for producing the surface structure. An ultra-short pulsed laser is exceptionally preferably used for this purpose, it further being preferable if the surface structure is produced under the influence of a process medium for increasing the efficiency and/or for passivation. Process gas, in particular inert gas, is advantageously used. The process gas is exceptionally preferably helium, which prevents the formation of an oxide layer on the first component, which preferably is made of steel or aluminum.

In one refinement of the present invention, it is advantageously provided that the radiation wavelength of the employed electromagnetic radiation, in particular the laser radiation, is selected from a value range between approximately 10 nm and approximately 11 μm. The wavelength is exceptionally preferably selected from a wavelength range between approximately 100 nm and approximately 1500 nm. It is additionally or alternatively preferable to select the radiation pulse duration, in particular the laser beam pulse duration, from a value range between approximately 10 fs and approximately 10 μs, particularly preferably between approximately 100 fs and approximately 100 μs. Through the selection of appropriate radiation parameters, the desired surface structure may be provided, having a microstructure overlaid by a nanostructure.

In order to implement exceptionally solid component composites it may be provided that the second contact surface, preferably the entire second component, is made of plastic, in particular a thermoplastic, and the first component is extrusion-coated by the second component, at least in sections. In addition to the integral connection using the adhesive layer, a form-fit connection is thus formed between the two components.

A specific embodiment is particularly preferred in which the first component and the second component have at least approximately equal coefficients of thermal expansion, to be able to ensure tightness even more reliably in the event of temperature variations.

It is particularly preferred if the component composite is an integral part of a fuel injector or a housing cover, in particular for a control unit or a sensor.

The present invention also relates to a method for manufacturing a component composite, in particular a component composite as described above.

An example method includes structuring a contact surface of a first component before applying the adhesive layer between the first and the second components. The core of the example method according to the present invention is that a surface structure is created on the first component, which has a microstructure overlaid by a nanostructure, the microstructure leading, in connection with the medium situated between the contact surfaces of the two components, in particular the adhesive layer, to an improved tightness of the resulting component composite, in particular between the first component and the adhesive layer.

It is exceptionally preferred if the surface structuring, which is implemented only on the first component but particularly preferably on the contact surfaces of both components, is performed with the aid of electromagnetic radiation, preferably under the influence of a process medium, in particular under a process gas atmosphere, in order to chemically change the component surface, for example, passivate it, and increase the structuring efficiency.

In a refinement of the present invention, it is advantageously provided that an ultra-short pulsed laser is used to produce the surface structure.

It is particularly preferable if the second component is connected to the first component in a form-fitting manner, preferably by extrusion-coating of the first component, in order to ensure a stable form fit in addition to the adhesion to the medium, in particular the adhesive layer, originating from the surface structuring.

Further advantages, features, and details of the present invention result from the following description of preferred exemplary embodiments and on the basis of the figures.

### BRIEF DESCRIPTION OF THE DRAWINGS

FIG. 1 shows a perspective view of a first component having a surface structure.

FIG. 2 shows an enlarged detail from FIG. 1, which schematically shows the surface structure.

FIG. 3 shows a component composite, in a sectional side view, including the first component shown in FIG. 1 and a second component, an adhesive layer being situated between the two components.

### DETAILED DESCRIPTION OF EXAMPLE EMBODIMENTS

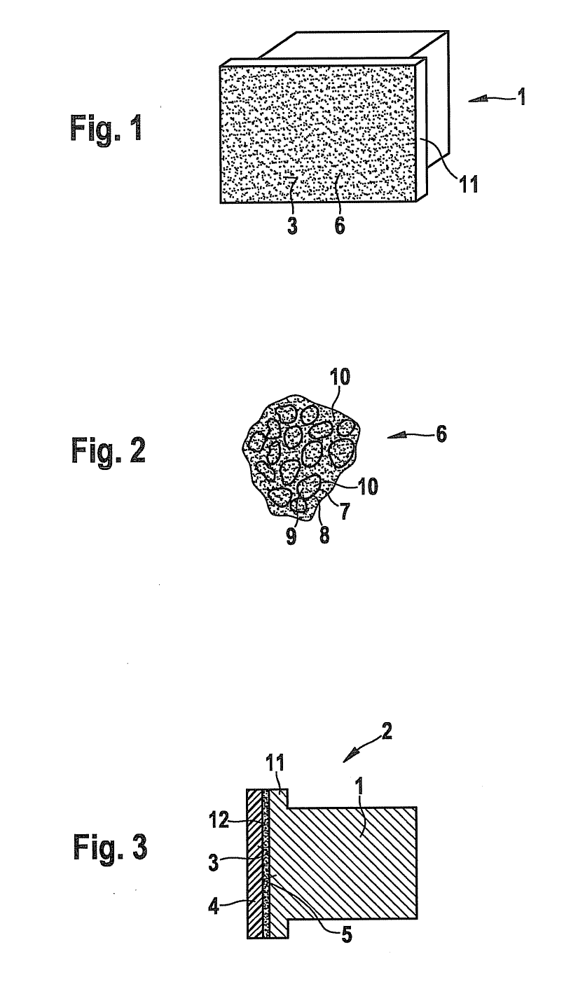

A first component 1 is shown in FIG. 1 as part of a component composite 2 shown in FIG. 3.

First component 1 is made of metal in the exemplary embodiment shown and includes a first contact surface 3, via which first component 1 is connected to a second component 4, which has a second contact surface 5, in component composite 2 shown in FIG. 3, using an interlayer of adhesive layer 12.

First component 1, more precisely first contact surface 3, is provided with a surface structure 6. This structure is schematically shown in FIG. 2 in an enlarged view. As shown in FIG. 1, first contact surface 3 is provided over its entire area with surface structure 6. Surface structure 6 shown in FIG. 2 includes a microstructure 7 having bulging and/or depressed microstructure elements 8. Microstructure elements 8 are provided with nanostructure elements 9 and a nanostructure 10, which is also located in the area outside microstructure elements 8. Particularly strong adhesive forces act between first component 1 and adhesive layer 12 in component composite 2 shown in FIG. 3 due to the nanostructured/microstructured component surface (first contact surface 3).

Unstructured first contact surface 3 is initially irradiated with the aid of a pulsed laser beam to manufacture surface structure 6. The laser beam is deflected with the aid of a scanner system in such a way that it scans the area of first component 1 to be structured. To produce the desired surface structure, a femtosecond, picosecond, or nanosecond laser may be used, preferably having a high pulse repetition frequency. The structuring process to manufacture surface structure 6 shown in FIG. 2 is preferably performed under a process gas, to influence the formation of an oxide layer on first component 1 made preferably from aluminum or steel. The advance with which the laser beam moves relative to first component 1 on first contact surface 3 is preferably between 100 mm/s and 10,000 mm/s.

To manufacture component composite 2 shown in FIG. 3, first component 1, more precisely first contact surface 3 having its surface structure 6, is connected to second component 4, using an interlayer of adhesive layer 12. Second component 4 may be made of metal, in particular steel, of plastic, in particular thermoplastic or duroplastic, or of a ceramic. In particular, it may be provided that second contact surface 5 of second component 4 is equipped with a surface structure 6 according to first contact surface 3 on first component 1.

It may also be provided in one specific embodiment (not shown) that first component 1 is at least partially extrusion-coated by second component 4. The form fit between both components 1, 4 is then ensured in that second component 4 encompasses a peripheral shoulder 11 of first component 1. Alternatively, for example, tabs, etc., which are extrusion-coated by second component 4, may be provided on first component 1. Second component 4 is then particularly preferably made of fiberglass-reinforced and/or mineral-reinforced plastics, preferably thermoplastics or duroplastics.

Various modifications of the exemplary embodiment described are also possible. It is thus possible, for example, that first contact surface 3 is provided only partially with a surface structure 6. Surface structure 6 may be produced not only with the aid of electromagnetic radiation, but also alternatively using electric structuring or mechanical structuring.

Other fields of application in addition to application in the automotive industry are all components which require force-locked, tight connections using an adhesive.

1-15. (canceled)

16. A component composite for a motor vehicle application, comprising:
a first component having a first contact surface, the first contact surface having a surface structure which has a microstructure overlaid by a nanostructure;
at least one second component having a second contact surface; and
an adhesive layer situated for integral connection between the first contact surface of the first component, and the second contact surface of the second component.

17. The component composite as recited in claim 16, wherein the second contact surface on the second component also has a surface structure having a microstructure overlaid by a nanostructure.

18. The component composite as recited in claim 16, wherein the surface structure is produced one of: i) with the aid of electromagnetic radiation, ii) with the aid of electric structuring, or iii) with the aid of mechanical structuring.

19. The component composite as recited in claim 16, wherein at least one of: i) the microstructure has microstructure elements having a diameter in a size range between approximately 1 μm and approximately 999 μm, and ii) the nanostructure has nanostructure elements having a diameter in a size range between approximately 1 nm and approximately 999 nm.

20. The component composite as recited in claim 16, wherein the surface structure is produced with the aid of a laser having a pulse duration between 100 fs and 100 μs.

21. The component composite as recited in claim 20, wherein the surface structure is produced under a process medium environment.

22. The component composite as recited in claim 20, wherein the surface structure is produced under a process gas atmosphere.

23. The component composite as recited in claim 16, wherein the surface structure is produced at least one of: i) with the aid of a radiation wavelength from a range between approximately 10 nm and approximately 11 μm, and ii) using a radiation pulse duration from a range between approximately 100 fs and approximately 10 μs.

24. The component composite as recited in claim 16, wherein the surface structure is produced at least one of: i) with the aid of a radiation wavelength from a range between approximately 100 nm and approximately 1500 nm, and ii) using a radiation pulse duration from a range between approximately 10 fs and approximately 100 μs.

25. The component composite as recited in claim 16, wherein the first contact surface is made of metal and the second contact surface is made of at least one of: metal, steel, plastic, thermoplastic, duroplastic, or a ceramic.

26. The component composite as recited in claim 16, wherein the second contact surface is made of a thermoplastic, and the first component is extrusion-coated by the second component at least in sections.

27. The component composite as recited in claim 16, wherein the first component and the second component have at least approximately equal coefficients of thermal expansion.

28. The component composite as recited in claim 16, wherein the first contact surface and the second contact surface are provided over their entire area with the surface structure.

29. The component composite as recited in claim 16, wherein the component composite is an integral part of one of: i) a fuel injector or ii) a housing cover for one of a control unit or a sensor.

30. A method for manufacturing a component composite, the method comprising:
providing a first component having a first contact surface, the first contact surface being provided with a surface structure which has a microstructure overlaid by a nanostructure;
providing at least one second component having a second contact surface; and
applying an adhesive layer between the first contact surface and the second contact surface for integral connection of the first contact surface and the second contact surface.

31. The method as recited in claim 30, wherein the surface structuring is produced with the aid of electromagnetic radiation on at least one of the first contact surface and the second contact surfaces, and the surface structuring is performed under a process gas atmosphere.

32. The method as recited in claim 31, wherein the structuring is performed under a process gas atmosphere at least one of: i) for passivation, and ii) for increasing efficiency.

33. The method as recited in claim 30, wherein the surface structure is produced with the aid of a laser having a pulse duration between 100 fs and 100 μs.

34. The method as recited in claim 30, wherein the first component is connected in a form-fitting manner to the second component by extrusion-coating of the first component, at least in sections, using the second component, at least some sections of which are made of plastic material.
